(19) United States
(12) Patent Application Publication
(10) Pub. No.: US 2017/0361191 A1
(43) Pub. Date: Dec. 21, 2017

(54) METHOD AND APPARATUS FOR IMPROVED ATHLETE TRAINING

(71) Applicant: Jerry Petty, Seattle, WA (US)

(72) Inventor: Jerry Petty, Seattle, WA (US)

(21) Appl. No.: 15/624,515

(22) Filed: Jun. 15, 2017

Related U.S. Application Data
(60) Provisional application No. 62/350,270, filed on Jun. 15, 2016.

(51) Int. Cl. A63B 69/00; A01K 15/02; A63B 71/02

(52) U.S. Cl. CPC A63B 69/0071; A63B 71/023; A01K 15/027; A63B 69/0057; A63B 2225/093

(57) ABSTRACT

A training system having a support structure, where the support structure includes two or more supports forming a tunnel shape, resulting in two or more openings in the structure. The supports of the support structure also having one or more adjustment mechanisms and skin pieces. The supports, the ground, and a boundary wall defining an inner training area. The inner training area being adjustable in volume.

### PRIORITY CLAIM

This application claims priority to U.S. Provisional Patent Application Ser. No. 62/350,270 filed Jun. 15, 2016, the entirety of which is hereby incorporated by reference as if fully set forth herein.

### BACKGROUND OF THE INVENTION

In many sports and activities the ability to keep your body in as low a position as possible is beneficial. Until now, those wanting to train athletes or others to maintain a lower position, or to traverse various obstacles along a given route, have relied on one or more people holding objects in the path of an athlete. This not only requires additional man power but also is limited in effectiveness as the athlete can immediately raise or otherwise change their position after traversing short obstacles. The present invention provides a solution to these and additional shortcomings of the prior art. The present invention solves the problem persistent in the prior art by providing an effective way of teaching athletes or others to stay lower for longer periods of time and further by providing adjustability for maximum individualization and therefore effectiveness regardless of user type, physiology, or experience.

Various aspects of the present invention may be described in terms of functional components and various steps. Such functional components may be realized by any number of hardware components configured to perform the specified functions and achieve the various results. For example, exemplary embodiments of the present invention may employ various adjustment mechanisms that may be integrated or part of or separate from other parts of the invention. A non-limiting list of adjustment mechanisms being, for example, closing a clamp, engaging pre-arranged pin locks, ratcheting arrangement, collapsible sections, inner and outer sliding sections, male and female helical threaded sections and the like, which may carry out a variety of functions. In addition, various aspects of the present invention may be practiced in conjunction with any number of other uses, and the systems and methods described are merely exemplary applications for the invention.

### BRIEF DESCRIPTION OF DRAWINGS

A more complete understanding of the present invention may be derived by referring to the detailed description and claims when considered in connection with the following illustrative figures.

FIG. 1 representatively illustrates an overhead view of one embodiment of the invention.

FIG. 2A representatively illustrates an overhead view according to one embodiment of the invention.

FIG. 2B representatively illustrates an overhead view according to one embodiment of the invention.

FIG. 2C representatively illustrates an overhead view according to one embodiment of the invention.

FIG. 3 representatively illustrates a partial front-side ¾ view according to one embodiment of the invention.

FIG. 4 representatively illustrates a side view according to one embodiment of the invention.

Elements and steps in the figures are illustrated for simplicity and clarity and have not necessarily been rendered according to any particular sequence. The invention described herein will be described according to the following orientation: from a viewpoint looking at the first opening of the invention face on, the opening being square to an X-Y plane with the remainder of the invention extending down the Z-axis.

### DETAILED DESCRIPTION OF EXEMPLARY EMBODIMENTS

Various representative implementations of the present invention may be applied to any system or apparatus for training athletes or others who can benefit from the aspects of the present invention. Certain representative implementations may include for example: a training-system on a basketball floor, football field, or track field.

In some embodiments the training-system may have hinges or other adjustment mechanisms allowing the training-system to go up and down, as well as in and out, or in any other direction or combination of direction which changes the area of the inner portion or inner training area. In this way, the training-system may be adjustable, allowing for use by athletes and users of all shapes and sizes. In other embodiments, there may be no, or little, adjustability.

In adjustable embodiments of the present invention, the adjustment may be mechanical in nature, pneumatic, digital, manual, automatic or any combination of those. For example, in a pneumatic digital system, the tunnel-system may be adjusted according to a computer program in real time in response to an athlete's progress. Users may also not be limited to athletes or even humans, the system may be used for animal training, for example. In other systems the adjustment may be done by hand.

In some embodiments, additional barriers or obstacles may also be installed in the interior of the invention. For example, the supports may have receptacles for installation of horizontal, diagonal, or vertical barriers, requiring users to traverse additional obstacles.

In one or more embodiments the ground plane, first plane, or bottom of the invention may be composed of various additional structures, for example soft mats, flotations devices for use in liquid environments, hard surfaces, additional barriers, or any other surface beneficial for the end use. These various different first planes may be switchable, such that the system can be adapted to different uses by buying or enabling different components. In other embodiments the ground plane or bottom is simply the surface upon which the invention is resting.

In various embodiments the training-system may include where the training-system is made out of vinyl, nylon, plastics or rubbers making it extremely safe for the user. The skin of the training-system may also be transparent, allowing a trainer, coach, or other observer to see the athlete or user while they are using the device. The training-system may also have rubber, or other suitable material, detachable feet allowing attachment to any surface without damage to the surface. The training-system provides a boundary in both width and height to a user traversing the inner training area, thereby requiring the athlete or user to adjust their form depending on the physical limitations imposed by the adjustable size of the inner training area.

In using the invention the user can set up the training-system wherever they desire to conduct training activities. Set up may include, for example, unpacking the training-system by moving the support mechanisms apart from one another in order to extend the training-system on its Z-axis. Other exemplary set up methods may require a user to build the system from a number of sub-components. The device can then be adjusted based on the height and width requirements of the user by utilizing the adjustment mechanism. As the user progresses in their training, for example becoming stronger, the device can continue to be lowered in order to remain effective. Other considerations for the overall size of the inner training area may include the user's skill, the user's height, and the training to be performed. Many other considerations may be taken into account when selecting the preferred orientation of the training-system. In addition, there may be many other uses contemplated by the end user. The disclosure herein does not limit the use of the invention to only those methods described. The methods described herein are exemplary in nature and non-exhaustive.

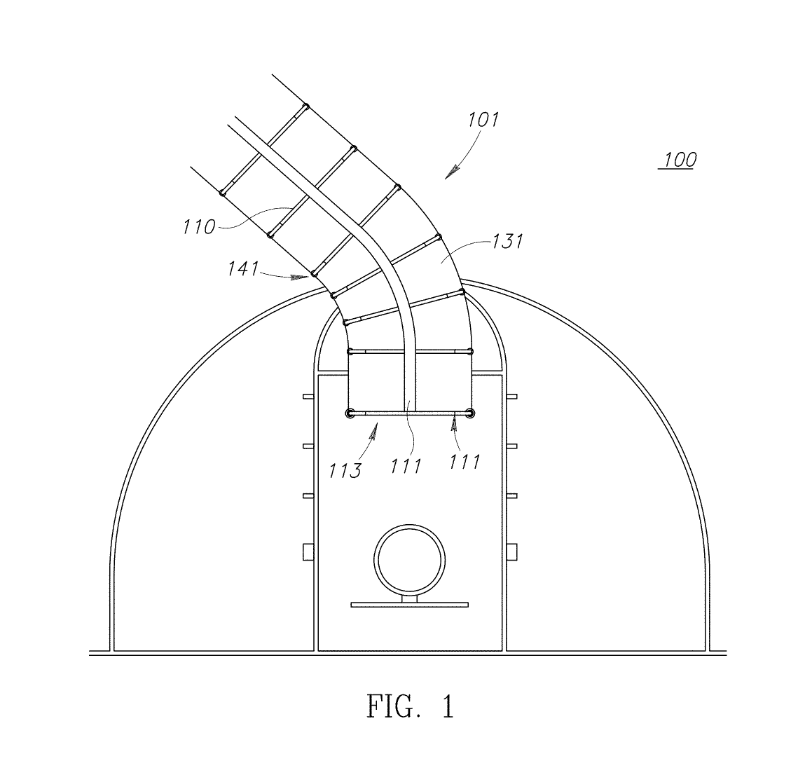

In accordance with one embodiment 100, a training-system 101 is illustrated in FIG. 1. FIG. 1 illustrates a top down view of the training system, this representative embodiment being located, for purely illustrative purposes, on a basketball court. The training-system includes at a support mechanism itself made of a number of supports 110. As depicted, the training system 101 is comprised of a number of supports 110 that span the invention forming the overall support mechanism. In embodiment 100, the supports 110 form an upside-down U shape terminating at the darkened circles on either side of opening 113. The opening 113 itself being formed by the terminal support, or said another way, where the support has no neighboring support on one or more sides. Many designs and orientation systems of the supports may be possible beyond those depicted in training system 101. These various shapes may collectively be referred to as tunnel shapes. In a more complex example, multiple supports 110 may be used at the same location. Placing multiple supports 110 at one location may be necessary in places of increased load, an opening 113, for example. In an additional possible embodiment, however, the support mechanisms 110 may form other tunnel shapes, several non-limiting examples include: a half circle, half oval, square, rectangle, triangle, or any other combination of shapes or other polygonal form terminating at the floor on either side at feet 141, forming a generally open and passable system. In another possible embodiment, the supports 110 do not terminate at two points at the ground or floor and instead may extend along the ground or floor and form a complete polygonal shape. In such an embodiment may still include feet 141 or may forego them. The supports 110 may also be made of any suitable material or combination of materials, a non-limiting and exemplary list of which could include any combination of commercially available plastics, metals, natural materials, and any other material capable of holding its form and providing suitable structure. The supports 110 may also be made of more than one piece. For example, the supports 110 may be capable of being broken down into smaller parts or components. Supports may also run along the Z-axis of the invention. Supports may also only extend down the Z-axis, these Z-supports may not come into contact with a ground or first surface. The Z-supports may also not be perfectly perpendicular to other supports, for example they may be horizontal in nature, and need to be straight. The term z-support simply refers to a support which points in a generally different, direction that the x-y plain supports described elsewhere. As depicted in training-system 101, the distance between any two supports 110 on the Z-axis can be adjusted closer or further from one another. This allows the training-system 101 to take on different shapes, including the bend depicted in FIG. 1. By adjusting the relative positioning of the plurality of support structure components, the user 102 can customize the training-system to their specific needs. This also allows the device 101, in one arrangement, to be collapsed, by placing all of the supports 101 next to one another, allowing for easier transport.

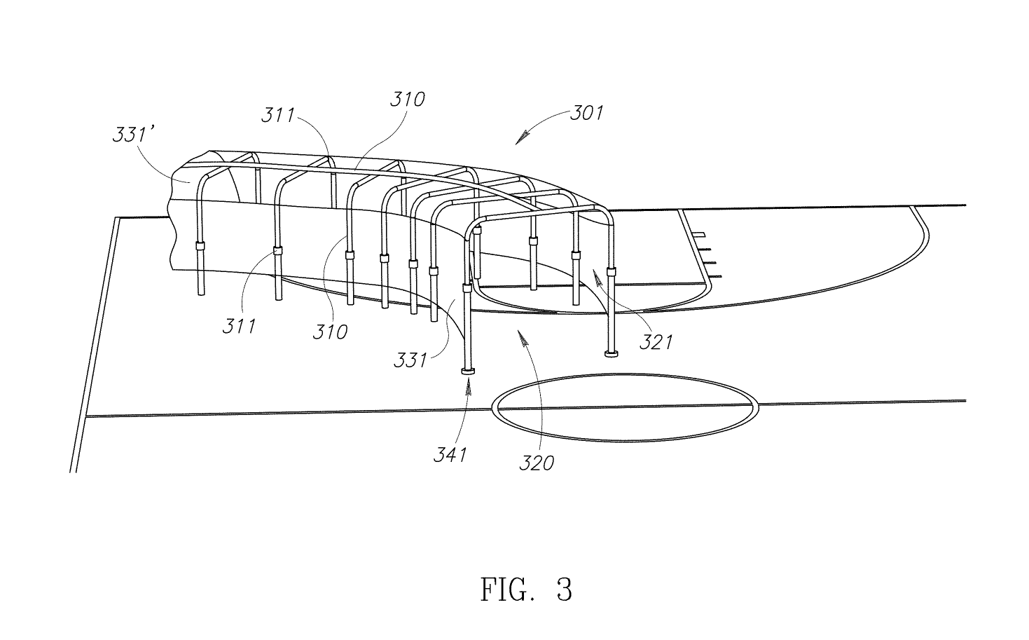

Training systems according to various embodiments of the invention may also include an adjustment mechanism 111. Training-system 101, for example, includes multiple adjustment mechanisms, or points of adjustment, 111 allowing for adjustment of the length or width of the individual supports 110. By adjusting the support(s) 110 on training system 101 the size of the training-system 101 and or the area of the inner training area, depicted as 320 in FIG. 3, can be changed. This allows for increased individualization and effectiveness as training-system 101 can be adjusted for each individual user 102 by engaging one or more adjustment mechanism 111. The adjustment mechanism may take many different forms known in the art and may be separate, integrated, or a combination of the two with the support itself. For example, the adjuster 111 could be a collapsible section. Or in an additional exemplary embodiment the adjuster may be built into a multi-section support 110. In this non-limiting example the support 110 may have an inner and outer piece where the inner piece can slide within the outer piece. An additional component may be required to lock the relative position of the two pieces, a spring loaded pin or tightening collar, for example. According to this example, adjustments may be made by repositioning the inner and outer pieces of support 110 relative to each other. In this exemplary embodiment, the user could then select a size by closing a clamp, engaging pre-arranged pin locks, ratcheting arrangement or any other means known in the art for temporarily or reversibly fixing the relative positions of the inner and outer pieces. In at least one example, there may be more than one adjustment mechanism or point of adjustment on any given support structure corresponding to any ratio of X/Y-axis adjustment at any adjustment point. In a further example, an upper adjuster may span the entire Z length of the invention. In this embodiment, the adjuster along the top may allow adjustment in the X plane (width) along the Z-axis (length) of the device. The full length adjustment mechanism 111 may be, for example, a hinge or clamp arrangement capable of being opened to allow adjustment of the support mechanism and or skin to be ideally positioned and then closed to secure the support mechanism and or the skin at its new size.

Training system 101 also includes a skin 131 coupled to the supports 110. The skin 131 forms a barrier between the outside of the training-system 101 and the inside, the inside is also called the inner training area 120. The skin 131 may be made of any suitable material. In at least one non-limiting example, the skin 131 may be made of plastic. In further non-limiting examples, the skin 131 may be made of canvas, plastic, rubber, vinyl, nylon, cotton, polyester, or any other natural, synthetic, or blended material suitably light and flexible. In one embodiment of the invention, the skin 131 is removably attached to the supports 110. The skin 131 may be composed of any system for connectively covering the supports 110. The skin 131 may be composed of one continuous piece of material or of many pieces of material in one or multiple layers. As depicted in training-system 101, when disposed on to the support 110 the skin 131 creates the overall shape of the training-system 101, covering any space between supports 110, and following, generally, the overall shape of the support mechanism. The skin may flex or fold as necessary, without damage, and can be re-positioned at a more extended or retracted position depending on the particular shape of the training-system desired. The skin may also have various properties depending on the application, for example, floatation, hydrodynamic, wind resistant (holes), waterproof, or the like. In additional embodiments, the skin 131 may be removably attached to the supports 110 in such a way that the skin 131 is disposed beneath or rests above the supports 110. The skin 131 may be attached in any number of ways, including permanently or removably, a non-limiting purely exemplary list of which may include, snaps, zippers, Velcro®, sewn to the support, ties, bands, clips, or any other means known in the art for reliably and optionally removably attaching skin 131 to a support frame. In an embodiment utilizing multiple layers of skin, the methods of attachment for each layer may be different. For example, in an embodiment with non-adjustable supports, one layer of skin may attach to the outside of the support 110 while another is attached to a second end of an adjustment mechanism 111, the first end of the adjustment mechanism being adjustably attached, along the length of the adjustment mechanism, to the non-adjustable support structure 110. In such an embodiment, it would be possible to maintain a constant exterior volume of a training-system while the interior volume, athlete training area, is adjusted. The adjustment mechanism adjusts the position of the inner or outer skin 131 thereby increasing or reducing the volume of the inner training area 120. In such an embodiment, the support mechanism 110 may be fixed while the skin 131 moves relative to the support 110.

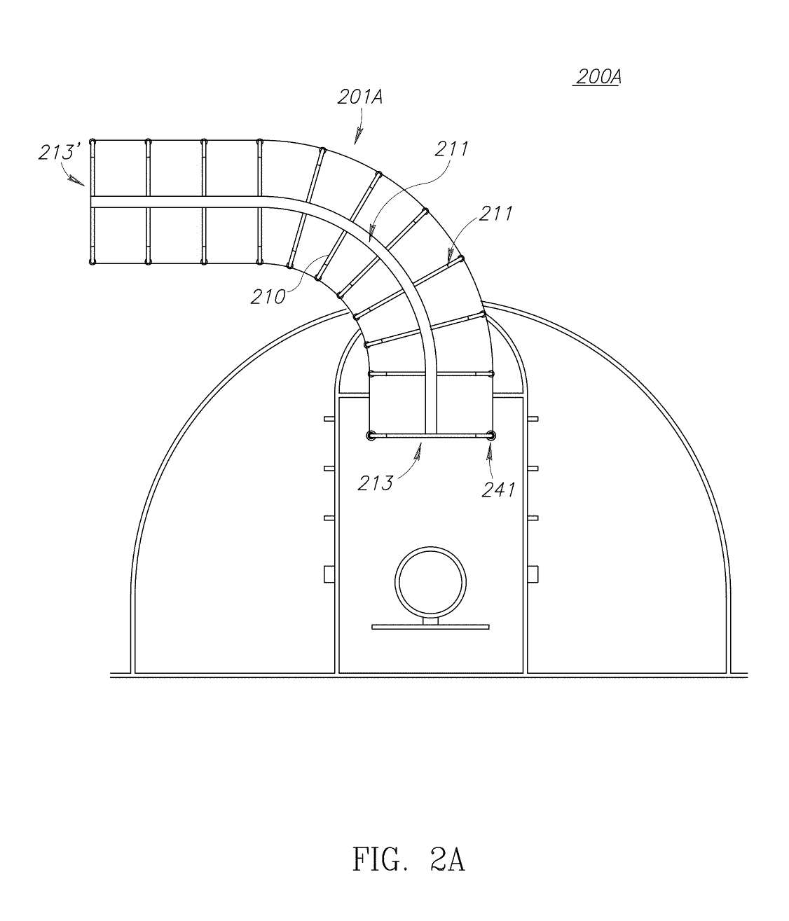

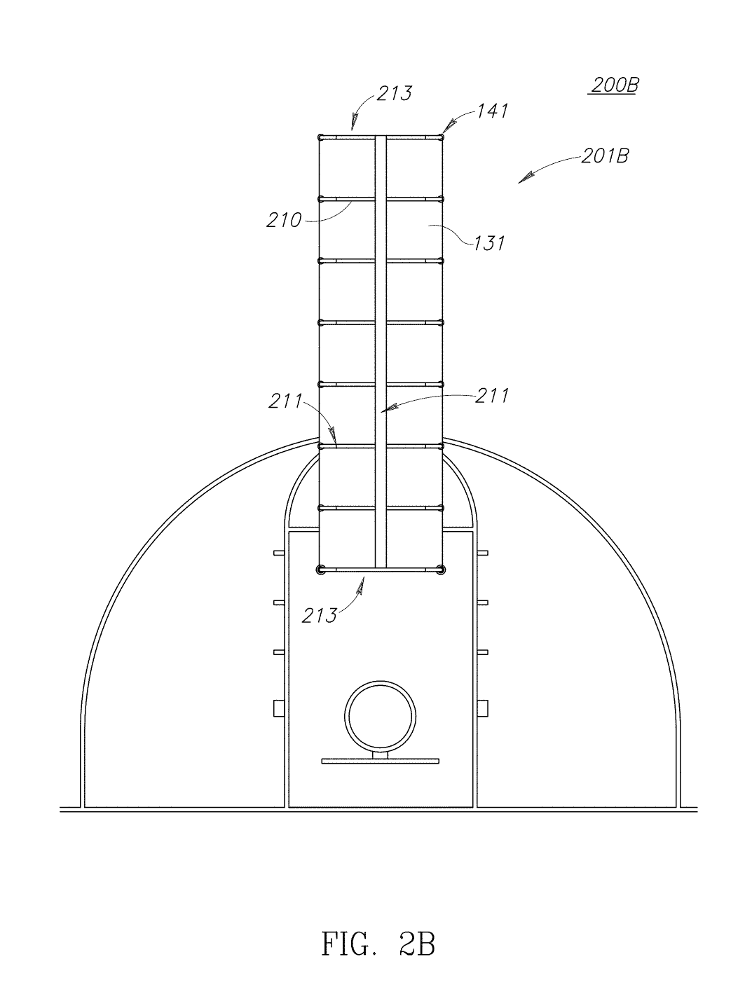

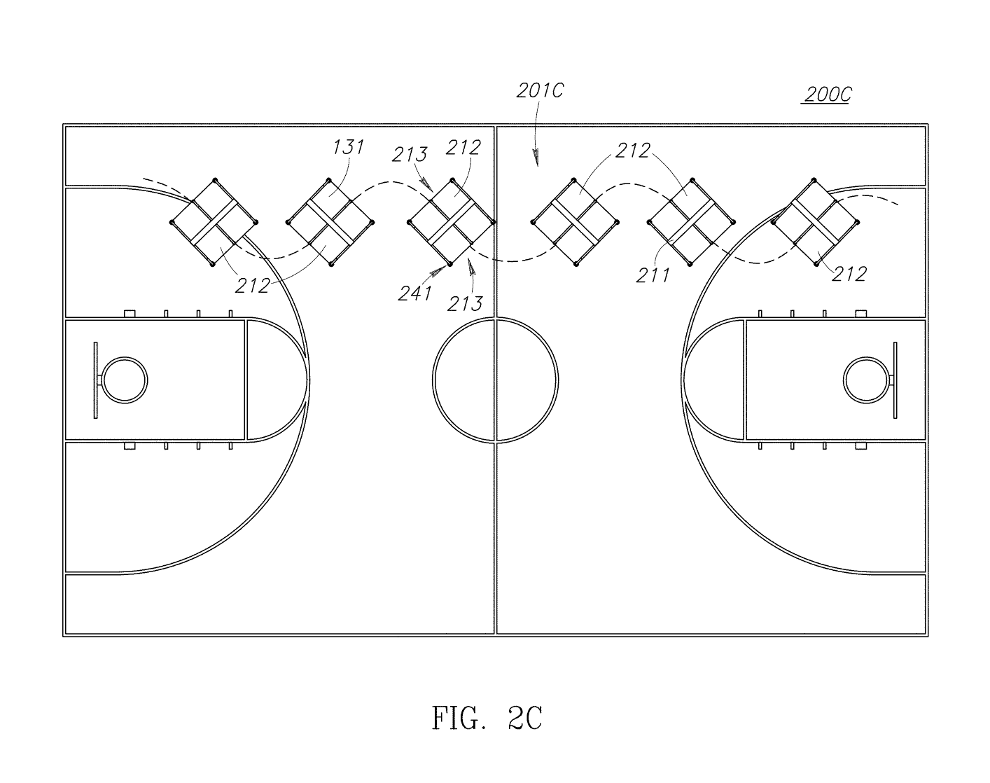

FIGS. 2A, 2B, and 2C illustrate various embodiments and orientations of the present invention. FIG. 2A illustrates a top down view of an embodiment depicting a bent orientation more severe than that depicted in FIG. 1, for example. The bend is accomplished by placing a number of supports 110 in close proximity to one another on one side, and adjusting the opposite side supports 110 further from their adjacent support. In embodiments with Z-axis supports in addition to X-Y axis supports, it may be necessary to engage an adjustment mechanism 111 on the Z-axis support in order to lengthen or collapse as necessary to allow for different structures. In embodiment 201A, a user may enter from, for example, the side away from the basketball hoop at opening 213, traversing the length of training system 201A to arrive at opening 213 nearer the hoop. Training-system 211A also depicts where different size feet 241 are optionally used depending on the load needs at the particular location. The level of security, or said another way, how much force can be applied before the foot or feet 241 begin to shift either laterally or vertically, can be selected by the user. In order to achieve this, the feet 241 may be removably attached such that other types, methods, and strengths of ground engagement are possible. The feet 241 may also be made of materials having varying coefficients of static or kinetic friction and designs allowing the invention to perform on different surface types or according to the individual demands of the user. For example, when the invention is used on a gymnasium floor, such as training system 201A, weighted rubber could be used. In another setting, such as a grass field, weighted bags, stakes, or other methods may be used to secure the training-system to the ground. The feet may use any system for interchangeability. For example, the feet may be removably attached by, but not limited to, threads, clips, clasps, snaps, friction fit, or any other means known in the art.

As depicted in FIG. 2B, the distance between supports 210 may be equal from side to side, resulting in the training system 201B forming a straight orientation. A user may change the orientation of the training system from 201B to 201A, in FIG. 2A, for example, or from 201A to 201B depending on the intended use and user preference.

FIG. 2C demonstrates yet another embodiment of the training-system 201C. In the depicted embodiment, the skin 231 may be detached from the support structures 210 as necessary to create smaller versions of the overall training-system 201C. Or, conversely, smaller sections may be used. The segments of the training-system 201C may be arranged individually along the length of a court or field, requiring the user to traverse them individually. FIG. 2C demonstrates one possible embodiment of such a setup. In another embodiment of the invention, multiples of the training-system may be used at any one time. While the components of training system 201C, as depicted, are all straight and utilize the same number of supports the invention is not so limited. Different embodiments may vary both the shape and number of supports, as well as size of the training-system.

FIG. 3 illustrates a front three quarter view of an embodiment 300 of the training-system 301. As illustrated, the training-system 301 includes a number of supports 310, including a support 310 along the upper portion of the training-system 301 that extends along Z-axis.

Training system 301 also includes multiple adjustment mechanisms 311 on the supports including two on each vertical portion, and two along the top portion. This combination of adjustment mechanisms 311 allows for training-system 311 to be adjusted for height and width as necessary. Such a combination of adjustment mechanism can be used on any number of other arrangements and embodiments. Further, additional or fewer adjustment mechanisms could be used as necessary. For example, only the adjustment mechanisms 311 depicted on the vertical portions could be used, resulting in an embodiment with only height adjustment. The adjustments may be made using an adjustment mechanism 311 that is built into the support mechanism 310 as depicted in 301. In additional exemplary embodiments, the adjustment mechanism 311 may be separate from the support mechanism 310. In further examples, only select support mechanisms 310 may have adjustment mechanisms 311 or alternatively, there may be no adjustment mechanism at all.

As depicted in FIG. 3 there may be multiple adjustment mechanisms 311, and therefore points of adjustment, on any given support 310. Utilizing the adjustment mechanism 311 allows for fine adjustment of the training-system 301, for example, a non-limiting and purely exemplary range may include where the training-system 301 has a starting value with a width of 4 ft, and a height of 4 ft and can be adjusted to a minimum width of 2 ft and a minimum height of 2 ft and further where the same embodiment can increase to a maximum width of 7 ft and a maximum height of 7 ft. Should the user desire, the invention can be adjusted to maximum height and minimum width at the same time and conversely minimum height and maximum width at the same time, or any position in between such extremes. In addition, referring back to FIG. 3 where there are multiple adjustment mechanisms 311 on multiple supports 310 along the length of the Z-axis of the invention, a user could choose to adjust the size of the invention in the X/Y plane at various Z points in order to decrease or increase or otherwise change the area of the training-system at different points along the Z-axis. This adjustability allows for a user to position the invention in such a way as to truly individualize the invention to the user's needs.

The internals of training-system 301 are also depicted, including the inner training area 320. The inner training area 320 comprises the area inside the training-system 301 through which a user can traverse. The edge of the inner trainer area is the boundary wall 321. The boundary wall 321 provides a barrier, or boundary, for the user thereby directing them through the training-system. In some embodiments, the boundary wall 321 is simply the inner side of the outer skin 331, in other embodiments it may be a separate component. In additional embodiments, such as the one depicted, the boundary wall 321 and the supports 310 provide a barrier to a user, whereas in other embodiments the boundary wall 321 may form a complete barrier, obscuring the supports 310. The boundary wall 321 may also be made of more than one piece or component, and may optionally cover only a portion of the boundary edge of the inner training area, for example along the top most section and the sides. The boundary wall 321 of the interior training area 320 is adjusted in order to restrict the movement of a user in the preferred manner. For example, the interior training area 320 is reduced such that the height of the upper portion of the boundary wall 321 is lower than the user is tall, requiring the user to adjust their position while working their way through the inner training area 320.

The skin 331 as depicted in the present exemplary embodiment 300 of training-system 301 is composed of two separate pieces 331 and 311′. Skin portion 331 is connected to the various supports 311 along their vertical portions while skin 311′ covers the upper portions of the system 301. The locations of these pieces, as well as the number of pieces, should not be considered as limiting. The location and number of pieces of skin 331 can vary depending on the intended use and user requirements. According to the depicted embodiment, skin 331′ is translucent, or clear, allowing the inner training area 320 to be viable from the outside. This allows a coach or other users to observe a user traversing the system 301 in order to check form, observe safety, or for any other reason. Skin section 331, according to this embodiment, is not translucent or clear, and cannot be seen through. In other embodiments, sections 331 may be clear while 331′ is translucent. The ability to observe a user traversing the inner training area has significant benefits in an athletic training environment, allowing for a coach to provide feedback, in addition to allowing an athlete to film themselves in order to critique their form, for example.

The training-system 301 having a skin 331 to form its overall shape begins and terminates along its Z-axis in openings 313 at either end. In the depicted embodiment, the openings 313 follow the same shape as the invention itself, and therefore the support(s) 310. In other embodiments however, the openings 313 may be adapted to any shape or style in order to meet user demands or, in adjustable variations, by utilizing the adjustment mechanism 311 at only the openings 313, the openings 313 may have a different size or shape to the rest of the invention. In other examples, additional openings 313 may be made by removing portions of the skin 331 at points throughout the invention.

Training system 301 also includes a Z-axis support, or Z-support 310. As depicted, this support is located at the top of the other supports 310 and differs in that it does not contact the ground, or first plain. In other embodiments Z-Axis supports 310 may contact the ground.

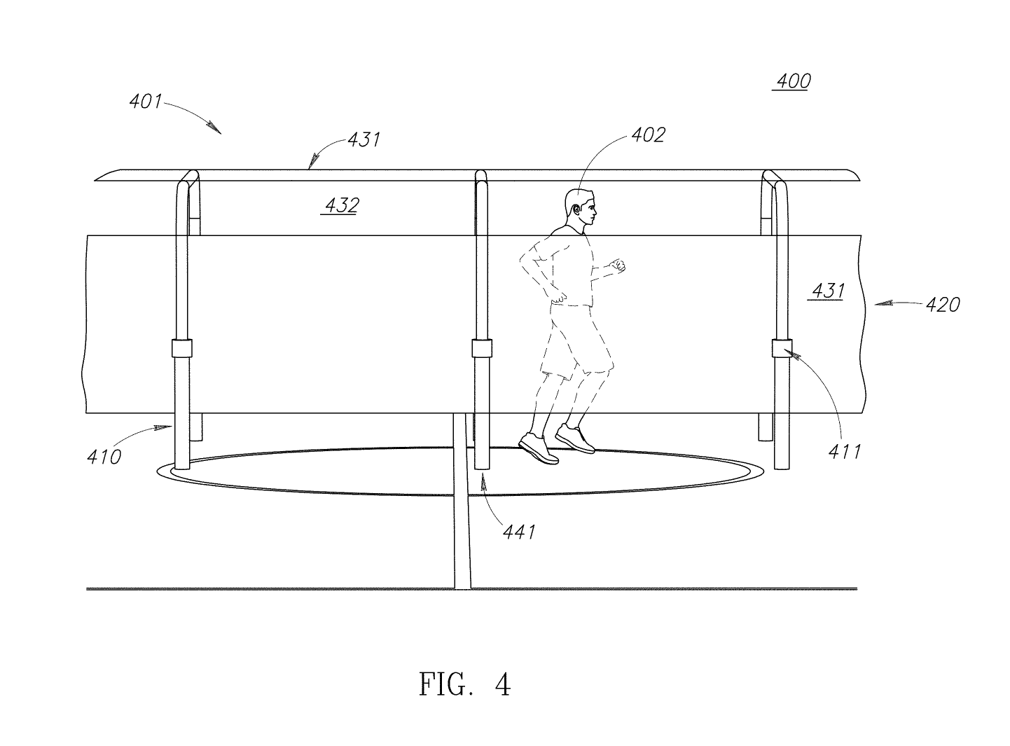

FIG. 4 illustrates a side view of an embodiment 400 of training-system 401 as well as a user 402 traversing the system. As depicted, user 402 is located in the inner training area 420. The support(s) 410 are arranged in an upside-down U configuration, the upper portion of which is located above the user's head, and include multiple adjustment points 411. In this embodiment, the skin 431 is composed of two separate panels, a side panel and an upper panel, however in this non-limiting embodiment, these two skin 431 pieces do not meet. Instead, as depicted, viewing window 432 is formed where there are no skin 431 portions leaving a gap through which the inner training area is visible. This provides the same benefits of a translucent or clear panel, but may be preferable in some situations in order to reduce heat, increase airflow, or reduce surface area.

In the foregoing specification, the invention has been described with reference to specific exemplary embodiments. Various modifications and changes may be made, however, without departing from the scope of the present invention. The specification and figures are illustrative, not restrictive, and modifications are intended to be included within the scope of the present invention.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

I claim:

1. A training-system comprising:
a support structure, the support structure comprising:
two or more supports extending from a first point on a first surface to a second point on the first surface, wherein the two or more supports form a tunnel shape having at least two openings; and,
at least one adjustment mechanism coupled to one of the two or more supports;
one or more skin pieces removably connected to at least one of the two or more supports;
wherein the two or more supports, the ground plane, and a boundary wall define an inner training area; and,
wherein the at least one adjustment mechanism allows for adjustment of the volume of the inner training area.

2. The training system according to claim 1, wherein the support structure comprises two or more adjustment mechanisms coupled to the two or more supports.

3. The apparatus according to claim 2, wherein at least one adjustment mechanism is a part of at least one of the two or more supports.

4. The apparatus according to claim 1, wherein the two or more supports extend along the first surface connecting the first and second points.

5. The apparatus according to claim 1, wherein one or more of the skin pieces is transparent.

6. The apparatus according to claim 1, wherein the one or more skin pieces form a first viewing window and further wherein the inner training area is visible through the first viewing window.

7. The apparatus according to claim 1, wherein the one or more skin pieces form a first viewing window on one side of the inner training area and a second viewing window on an opposing side of the inner training area.

8. The apparatus according to claim 1, wherein the boundary wall is deposed between the inner training area and at least a portion of the plurality of supports.

9. The apparatus according to claim 8, wherein the boundary wall comprises two or more pieces.

10. The apparatus according to claim 9, wherein the two or more pieces of the boundary wall are transparent.

11. The apparatus according to claim 1, wherein the volume of the inner training area may be adjusted in width and in height, and further wherein the volume may be adjusted between the range of 50% and 150% of a starting value.

12. A training-system, comprising:
a support structure, the support structure comprising a plurality of supports, wherein the plurality of supports form a tunnel shape having at least two openings;
one or more skin pieces removably connected to at least one of the plurality of supports; and
a boundary wall, wherein the support structure and the boundary wall define an inner training area.

13. The apparatus according to claim 12, wherein at least one of the one or more skin pieces is transparent.

14. The apparatus according to claim 12, wherein one or more adjustment mechanisms is coupled to at least one of the plurality of supports.

15. The apparatus according to claim 14, wherein one or more adjustment mechanisms is a part of at least one of the plurality of supports.

16. The apparatus according to claim 12, wherein the area of the inner training area is adjustable.

17. The apparatus according to claim 12, wherein the support structure further comprises one or more additional Z-plain supports.

18. The apparatus according to claim 14, wherein the one or more adjustment mechanisms comprises an inner and outer portion of the support, wherein the inner piece selectively slides within the outer portion.

19. The apparatus according to claim 12, wherein the boundary wall is deposed between the inner training area and only a portion of the plurality of supports.

20. A method of training comprising the steps of:
expanding a training device to define a training area;
placing the training device in a preferred location;
adjusting the volume of the training area by engaging a plurality of adjustment points of the training device, wherein the adjusting step is based on at least one parameter from the group of:
the user's height;
the user's skill; and
the type of training desired; and
selectively adjusting the training device to a desired shape to change a difficulty level associated with the training device.
